(19) United States
(12) Patent Application Publication
(10) Pub. No.: US 2020/0063807 A1
(43) Pub. Date: Feb. 27, 2020

(54) HYDRODYNAMIC MACHINE, IN PARTICULAR HYDRODYNAMIC CONVERTER

(71) Applicant: VOITH PATENT GMBH, Heidenheim (DE)

(72) Inventor: PETER GORETZKI, WALLHAUSEN (DE)

(21) Appl. No.: 16/610,601

(22) PCT Filed: Apr. 24, 2018
(86) PCT No.: PCT/EP2018/060392

§ 371 Date: Nov. 4, 2019

(30) Foreign Application Priority Data
May 2, 2017 (DE) 10 2017 109 310.9

(51) Int. Cl. F16D 33/10; F16H 41/30

(52) U.S. Cl. CPC F16D 33/10; F16H 47/085; F16H 41/30

(57) ABSTRACT

A hydrodynamic machine has a working chamber that may be filled with a working medium and in which a bladed pump impeller and a bladed turbine impeller are arranged to hydrodynamically transmit torque and/or drive power from the pump impeller to the turbine impeller. A working medium inlet and a working medium outlet are provided for inputting and discharging the working medium in/out of the working chamber. A control valve is furnished in the working medium inlet or in a bypass. The control valve changes the working medium quantity flowing into the working chamber. The control valve is connected to the working medium inlet and/or the working medium outlet and actuated such that the flow cross-section of the control valve is variably adjusted as a function of the working medium pressure in the working medium inlet and as a function of the working medium pressure in the working medium outlet.

The present invention relates to a hydrodynamic machine, in particular a hydrodynamic converter, according to the preamble of claim 1.

Hydrodynamic machines are used to transmit drive power hydrodynamically and without wear. For this purpose, hydrodynamic machines have at least one pump impeller and at least one turbine impeller that are positioned together in a working chamber which may be filled with working medium, so that the pump impeller drives the turbine impeller via a hydrodynamic circuit flow of the working medium in the working chamber, and torque and drive power are transmitted. The pump impeller thus converts mechanical drive power into flow energy or flow power and the turbine impeller converts flow energy or flow power back into mechanical drive power.

The working medium, in particular oil, has the additional task of dissipating the heat generated in the working chamber out of the working chamber. In order to achieve the best possible efficiency, for example, in the case of a hydrodynamic converter, in particular a counter-rotating converter the pump impeller and turbine impeller of which rotate in opposite directions to each other, the highest possible outlet temperatures of the working medium are sought, in particular approximately 95° C. The heating of the working medium in the hydrodynamic machine is proportional to the power loss and inversely proportional to the working medium quantity discharged from a working medium inlet into the working chamber and out of this working chamber via a working medium outlet.

WO 2012/143123 A1 discloses a generic hydrodynamic converter designed as a counter-rotating converter.

Such a hydrodynamic converter is, for example, supplied with oil or working medium by means of an oil pump, generally a working medium pump. The working medium pump may be part of a working medium supply, in the case of oil an oil supply, in which the working medium pump delivers the working medium at least indirectly or directly from a working medium sump or oil sump and feeds it into the working medium inlet of the converter. The converter in this case has a required filling pressure, which the working medium pump must generate accordingly while consuming power. Heretofore, it has been envisioned that the working medium pump conveys the working medium at a constant pressure and that this working medium is fed into the working chamber via the working medium inlet.

DE 10 2007 030 281 A1 discloses a hydrodynamic coupling with a working chamber and an ancillary chamber for receiving the working medium not in the working chamber. The working chamber and the ancillary chamber are connected to each other via an inlet channel and a return channel in a flow-conducting or working medium-conducting manner. This allows a circuit flow to occur between the working chamber and the ancillary chamber. The working medium flows from the ancillary chamber into the working chamber via the inlet channel and from the working chamber back into the ancillary chamber via the return channel. In order to adjust the filling level of the working chamber, the flow cross-section for the working medium in the inlet channel and/or in the return channel may be varied in a targeted manner. The flow cross-section for the working medium in the inlet channel and/or return channel may be changed, for example, by furnishing a control valve in the inlet channel and/or return channel, which is designed for example as a solenoid valve. An alternative configuration provides for a clocked open-close valve.

According to one embodiment, the valve is designed as a directional valve with two positions and three connections, whereby in one position the inlet channel is blocked and the outlet channel is connected to the ancillary chamber so that the filling level of the working chamber is reduced, and in another position the valve allows a flow of working medium from the return channel and from the ancillary chamber into the working chamber. The valve is designed as an externally controllable control valve.

EP 0 427 589 A1 discloses a hydrodynamic coupling with a centrifugal valve that opens when the hydrodynamic coupling is at standstill. Alternatively, an electronically controlled valve may be furnished.

US 2007/0292272 A1 discloses an engine with a vertical crankshaft and a vertical output shaft below the crankshaft. A torque converter provides a connection between the crankshaft and the output shaft.

DE 10 2006 031 814 A1 discloses a hydrodynamic machine, in particular a hydrodynamic coupling, in which an inlet valve is furnished in the working medium inlet, which inlet valve has two switching positions of a valve body, namely a first switching position, in which the inlet valve releases a first flow cross-section for the working medium, and further a second switching position in which the inlet valve releases a second flow cross-section for the working medium, the second flow cross-section being smaller than the first flow cross-section. The respective switching position of the valve body is automatically set as a function of the pressure of the working medium in or at the inlet valve and/or the pressure difference of the working medium across the inlet valve, i.e. between a working medium inlet and a working medium outlet of the inlet valve. The hydrodynamic coupling may thus be used in oil systems with varying oil pressure, the inlet valve compensating for oil pressure fluctuations in such a way that the hydrodynamic coupling is subjected to more or less the same working medium pressure. To avoid having to regulate the entire working medium flow flowing into the hydrodynamic coupling accordingly, a bypass around the inlet valve may be furnished, via which part of the working medium is always fed into the working medium inlet of the hydrodynamic coupling.

In this way it is also ensured, in accordance with DE 10 2006 031 814 A1, that the hydrodynamic machine is at least largely subjected to the same working medium pressure in all operating ranges.

Although the hydrodynamic machines mentioned have thus far worked satisfactorily in practice, there is a need to increase efficiency.

The object of the present invention to provide a hydrodynamic machine that is improved from the standpoint of efficiency. The object is accomplished according to the invention by a hydrodynamic machine with the features of claim 1. In the dependent claims, advantageous and particularly expedient configurations of the invention are provided.

The present invention is based, first, on the knowledge that the conventional supplying of the hydrodynamic machine, in particular of a hydrodynamic converter designed for example as a counter-rotating converter and in particular as an actuating converter, with a constant filling pressure, leads to drawbacks from an efficiency standpoint. It has been found that the required filling pressure varies as a function of the speed, in particular the output speed, i.e. the speed of the turbine impeller, and/or as a function of the output torque, i.e. the torque applied to the turbine impeller.

Heretofore, the filling pressure has been set to the most unfavorable operating point and kept nearly constant over the entire operating characteristic map. Accordingly, the input power of a working medium pump, which is in particular proportional to the differential pressure across the working medium pump, is comparatively high over the entire characteristic map. In addition, an unnecessarily high filling pressure in a certain operating state leads to an unnecessarily high leakage of working medium from the hydrodynamic machine, for example via the seals thereof, which are designed in particular as non-contact seals. Finally, in a wide range of the characteristic map of the hydrodynamic machine, more working medium enters and leaves the working chamber than is necessary, resulting in comparatively lower outlet temperatures than with a lower working medium flow. In order to achieve the best possible efficiency, however, the highest possible outlet temperatures, for example 90° C., 95° C. or more, are sought, i.e. a corresponding temperature of the working medium in the working medium outlet of the hydrodynamic machine.

In particular, if the hydrodynamic machine is designed as a displacement converter, in which the ratio of the torque applied to the pump impeller to the torque applied to the turbine impeller is variable and may be adjusted or varied in a targeted manner by furnishing a corresponding actuating member, the required filling pressure is highest at minimum output speeds and minimum output torque, i.e. in an operating state in which the turbine impeller rotates at a comparatively low speed, and a comparatively low torque, for example less than half of the torque, is applied to the turbine impeller.

The required filling pressure is lowest at the nominal point of the hydrodynamic converter, at which in particular the maximum output speed and the maximum output torque are applied to the turbine impeller. The dynamic pressure, i.e. the pressure increase in the working chamber of the hydrodynamic converter caused by the pump impeller, is highest at the nominal point and lowest at the minimum output speed. At a constant filling pressure, this results in high leakage at the nominal point and low leakage at minimum output speed.

The pump impeller and/or a guide wheel may act as an actuating member of the converter, i.e. the blades of the pump impeller and/or the blades of the guide wheel may be adjusted in relation to the flow of the working medium in the working chamber, i.e. in relation to the flow in the working medium circuit in the working chamber, by being more or less adjustable in relation to the flow direction.

Accordingly, according to the invention, a control valve is furnished that adjusts the inlet pressure according to the requirements of the hydrodynamic machine at the respective operating point. For this purpose, in areas of the characteristic map with a low required inlet pressure, less pressurized working medium is fed via the working medium inlet into the working chamber and via the working medium outlet out of the working chamber than in areas of the characteristic map with a comparatively higher required inlet pressure. By this means, first, an operating point or nominal operating point, at which the pump efficiency is maximum, of a mechanically driven volumetric working medium pump in particular may be shifted to lower differential pressures across the pump, which results in a comparatively lower pump input power. Second, less working medium, in particular oil, enters the hydrodynamic machine, so that less working medium has to be accelerated in the working chamber. Furthermore, the temperature of the working medium exiting the working chamber rises, i.e. the working medium in the working medium outlet, which has a positive effect on efficiency.

In detail, a hydrodynamic machine that is designed in particular as a hydrodynamic converter, for example as a counter-rotating converter, has a working chamber that may be filled with a working medium and in which at least one bladed pump impeller, in particular exactly one individual bladed pump impeller, and at least one bladed turbine impeller, in particular one individual bladed turbine impeller, are arranged in order to transmit torque and/or drive power hydrodynamically from the pump impeller to the turbine impeller. The hydrodynamic machine has a working medium inlet for feeding working medium into the working chamber and a working medium outlet for discharging working medium from the working chamber. According to the invention, a control valve is furnished that is located in the working medium inlet or in a bypass for working medium that branches off from the working medium inlet. For example, the bypass flows at least indirectly or directly into a working medium sump, in particular an oil sump if oil is used as the working medium.

With the control valve, the working medium quantity that flows into the working chamber may be varied by adjusting a flow cross-section for the working medium flowing through the control valve. Accordingly, more working medium may flow through the control valve that has a comparatively larger flow cross-section than one that has a comparatively smaller flow cross-section. If the control valve is furnished in the bypass, then, with the comparatively larger flow cross-section, comparatively more working medium will flow past the working chamber via the bypass, so that the working medium quantity fed through the working chamber is comparatively less.

According to the invention, the control valve is connected to the working medium inlet and/or the working medium outlet and actuated such that the flow cross-section of the control valve is variably adjusted as a function of the working medium pressure in the working medium inlet and as a function of the working medium pressure in the working medium outlet.

For example, the control valve is connected both to the working medium inlet and the working medium outlet and pressurized at the working medium pressure to set the flow cross-section as desired. Thus, the flow cross-section of the control valve is changed or adjusted by applying the working medium pressure in the working medium inlet, and the working medium pressure working medium outlet, to the control valve. In particular, this makes it possible to dispense with electrical or electronic control of the control valve and to control the control valve exclusively mechanically or by means of the working medium pressure.

According to one embodiment of the invention, the control valve is arranged in the bypass and has a valve body that is preloaded by means of a preload element, which cooperates with a valve seat to limit and adjust the flow cross-section. The preload element is furnished in the control valve in such a way that it acts on the valve body in one closing direction of the control valve. If the control valve is furnished in the working medium inlet, the preload element may act on the valve body in the sense of opening.

The valve body may now be loaded with force against the preload force of the preload element as a function of the working medium pressure in the working medium inlet and as a function of the working medium pressure in the working medium outlet.

The preload force of the preload element is preferably variably adjustable, at least before the initial startup or restarting of the hydrodynamic machine. For example, an adjustable actuator is furnished, for example in the form of an adjusting screw or the like, which may be actuated, in particular manually, in order to change the preload force of the preload element.

According to one embodiment of the invention, the preload force acts against both a force applied to the valve body as a function of the working medium pressure in the working medium inlet and a force applied to the valve body as a function of the working medium pressure in the working medium outlet.

In particular, the control valve has a first working medium connection, a second working medium connection and a working medium outlet. The first working medium connection is connected to the working medium inlet in a working medium-conducting manner, the second working medium connection is connected to the working medium outlet in a working medium-conducting manner, and the first working medium connection is connected to the working medium outlet in a working medium-conducting manner via the variable flow cross-section. The first working medium connection and second working medium connection are respectively connected to the valve body in a working medium-conducting manner by means of their own active area or with a common active area, in order to pressurize the valve body against the preload force of the preload element.

In particular, the control valve is designed as a piston spool valve, and accordingly has a piston as the valve body.

The preload element may for example be designed as a compression spring, and in particular as a spiral compression spring.

For example, the compression spring acts on a first side of the valve body designed as a piston and the two active areas or the common active area is/are furnished on a side of the valve body opposite thereto.

The area ratio of the two active areas to each other may, for example, be designed as follows: The ratio of the active area to which the working medium inlet is connected, to the active area to which the working medium outlet is connected, is preferably in the range from 2.5 to 4.5.

The preload element may for example have a preload force between 1000 and 20,000 Newtons, as a function of the drive speed, converter size and valve parameters (diameter). According to one embodiment of the invention, the preload force of the preload element is 1.1 to 2.0 times at the design point or the set value of the product of the maximum inlet pressure of the hydrodynamic machine or the pressure in the working medium inlet of the hydrodynamic machine at the nominal operating point, multiplied by the active area that is connected to the working medium inlet in a working medium-conducting manner.

To limit the maximum working medium quantity flowing out, a throttle orifice may be furnished in the working medium outlet of the control valve. Such an orifice is then advantageously designed so as to take into account the power loss of the hydrodynamic machine within the characteristic map and the maximum pump flow rate of a working medium pump with regard to permissible temperatures, and may have a pure protective function against overheating of the hydrodynamic machine. Instead of a throttle orifice with a constant flow cross-section, an adjustable throttle, in particular a manually adjustable throttle, could in principle also be provided.

In particular, the first working medium connection of the control valve has a larger flow cross-section than the second working medium connection. In particular, the working medium flows from the first working medium connection through the variable flow cross-section of the control valve to the working medium outlet, whereas the second working medium connection serves only for transmitting pressure, and accordingly no outlet is assigned to the second working medium connection. Rather, only a static pressure of the working medium may build up in the second working medium connection.

In particular, the preload element is designed or preloaded in such a way that the elastic force of the preload element and the pressure force of the effective working medium pressure supplied via the two working medium connections are in equilibrium when the hydrodynamic machine is at a low output speed. This means that the maximum required filling pressure is set via the preload force. At this operating point of the hydrodynamic machine, the outlet pressure is in particular lower than the inlet pressure.

If the outlet pressure of the hydrodynamic machine, multiplied by the active area over which the working medium of the second working medium connection acts, added to the filling pressure (inlet pressure) of the hydrodynamic machine multiplied by the active area on which the working medium pressure from the first working medium connection acts, is greater than the set preload force of the preload element, the control valve opens and the working medium flows past the working chamber, in particular into the working medium sump. As a result, the filling pressure, and thus the system pressure upstream of the hydrodynamic machine, drops until an equilibrium is achieved.

The invention is particularly advantageous for a hydrodynamic machine in the form of a counter-rotating converter, in particular combined with a mechanically driven volumetric working medium pump.

Accordingly, a drive train according to the invention has a working medium pump which is connected to the working medium inlet of the hydrodynamic machine in a working medium-conducting manner by means of its pressure side, so as to supply the hydrodynamic machine, in particular the hydrodynamic converter, with pressurized working medium. The working medium pump also has a suction side that is connected directly or indirectly to a working medium sump, in particular an oil sump. The bypass opens into the working medium sump directly or indirectly. The invention makes it possible to achieve a lower pump input power than heretofore, by reducing the differential pressure across the working medium pump by means of a favorable shift in the operating point of the pump. Higher working medium temperatures inside the hydrodynamic machine may lead to lower oil viscosities, which improves the hydrodynamic properties and increases efficiency. The lower quantity of working medium that has to be accelerated within the working chamber by the pump impeller likewise has a positive effect on the efficiency of the hydrodynamic machine.

For example, in accordance with one embodiment of the present invention, the hydrodynamic machine, in particular the hydrodynamic converter, may be furnished in a hydrodynamic power branch of a transmission, where the transmission also has a purely mechanical power branch that is arranged parallel to the hydrodynamic branch with respect to transmitting drive power from a transmission input to a transmission output.

The transmission input may for example be an input shaft that rotates at least substantially at a constant speed, while in contrast, an output shaft forming the transmission output may be driven at variable speed. The term “shaft” in this case is defined broadly, so that it does not have to be a cylindrical solid shaft or hollow shaft; rather, any suitable element that may rotate may form the corresponding shaft.

For example, a superposition gear designed as a planetary gear is furnished in the transmission, comprising a ring gear, a sun gear and a planet carrier with one or more planets. The hydrodynamic converter may in particular be designed as a counter-rotating converter and the input shaft of the transmission may be directly connected to a pump impeller of the hydrodynamic converter and a first element of the planetary gear. The turbine impeller of the hydrodynamic converter is then preferably connected directly to a second element of the planetary gear and the output shaft of the transmission is connected to a third element of the planetary gear. The first element of the planetary gear is, for example, the planet carrier, the second element is the sun gear of the planetary gear and the third element is the ring gear of the planetary gear.

Preferably, a single planetary gear unit is furnished in the transmission. In the direction of the flow of drive power from the planetary gear to a driven machine downstream of the transmission, a speed transformation, for example into higher speed, may be furnished in particular.

The turbine impeller of the hydrodynamic converter is preferably connected via a hollow shaft to the sun gear of the planetary gear and an input shaft of the transmission that runs through the hollow shaft, which may be driven by a driving machine, is connected to the planet carrier, for example on the side of the planetary gear facing away from the hydrodynamic converter.

According to one embodiment, the ring gear on the side of the planetary gear facing away from the hydrodynamic converter is at least indirectly connected to the output shaft of the transmission.

The ring gear, the planets and the sun gear may be implemented as a single helical gearing.

The drive machine may for example be designed as an electric motor.

The working machine is, for example, a conveying device for a fluid, for example a compressor, a pump or a centrifugal pump.

The invention will be described by way of example below, with reference to the exemplary embodiments and the drawings.

The drawings show the following:

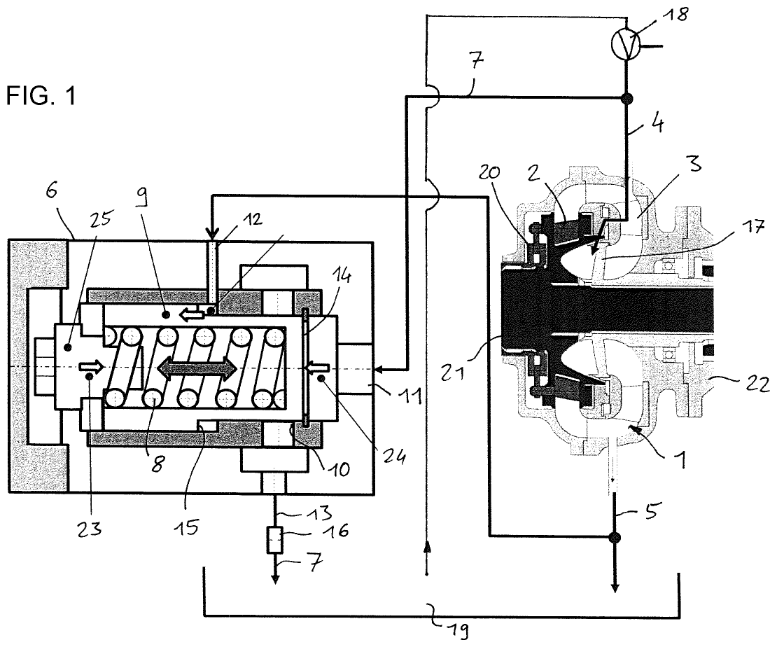

FIG. 1 shows an exemplary embodiment of a hydrodynamic machine in the form of a hydrodynamic converter with a control valve according to the invention;

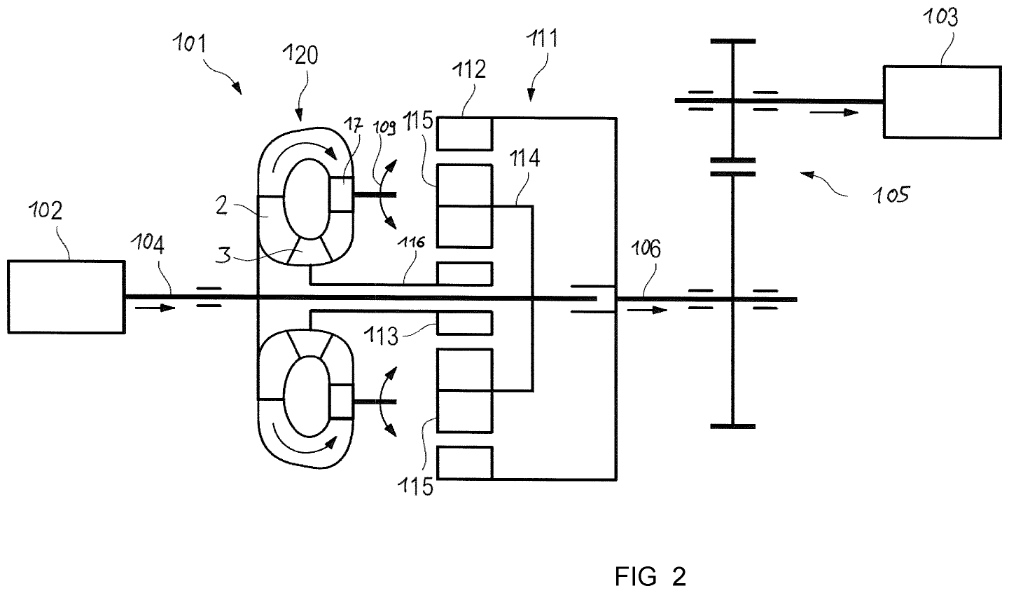

FIG. 2 shows a schematic representation of an exemplary embodiment of a transmission with a hydrodynamic machine according to the invention;

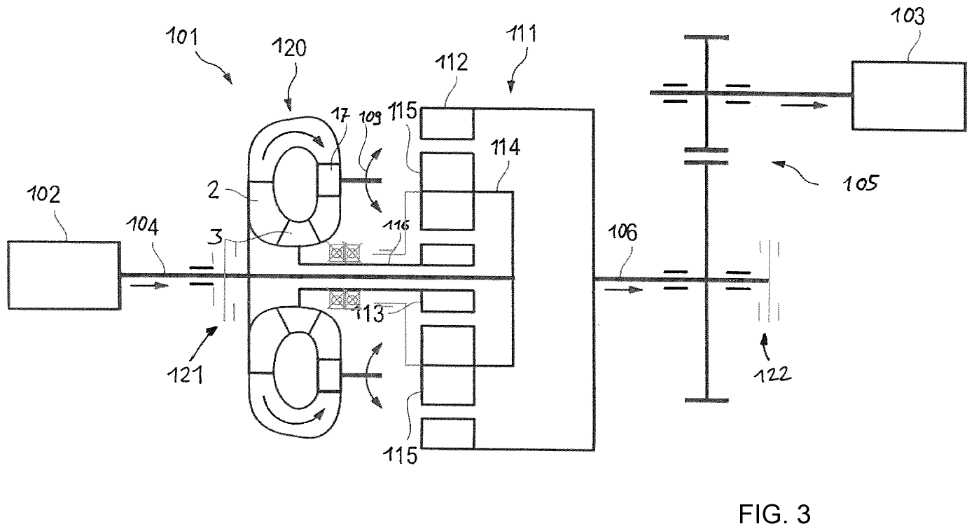

FIG. 3 is an embodiment modified with respect to FIG. 2.

FIG. 1 shows an exemplary hydrodynamic machine, which is designed in the form of a hydrodynamic converter, in this case an actuating converter, in particular a counter-rotating converter. A bladed pump impeller 2 is furnished in the working chamber 1, the pump blades of which may be adjusted along an axis transversely or at an angle to the flow direction of the working medium in a working medium circuit in the working chamber 1. The adjustment is carried out, for example, via an adjusting ring 20.

In the working chamber 1, the blades of a turbine impeller 3 are also furnished behind the pump impeller 2 or blades thereof in the flow direction of the working medium, followed by a guide wheel 17 or blades thereof, the guide wheel being in particular stationary.

Working medium is fed into the working chamber 1 via the working medium inlet 4 and discharged from the working chamber 1 via the working medium outlet 5.

The hydrodynamic machine has a drive shaft 21 that is mechanically connected to the pump impeller 2 and an output shaft 22 that is mechanically connected to the turbine impeller 3. The drive shaft 21 and/or output shaft 22 may in principle be implemented as a solid shaft or any suitable type of hollow shaft.

A bypass 7 branches off from the working medium inlet 4 and opens into a working medium sump 19. The working medium outlet 5 may also open into the working medium sump 19.

A control valve 6 is furnished in the bypass 7, which has a valve body 9 preloaded with a preload element 8. The force of the preload element 8 acts as indicated by the arrow marked 23. Opposing the force of the preload element 8, a pressure of the working medium acts on the valve body 9, which is fed from the working medium inlet 4 to a first working medium connection 11 of the control valve 6. This pressure acts on a first active area 14 of valve body 9, which together with a valve seat 10 adjusts the flow cross-section of the control valve.

The valve body 9 also has a second active area 15, on which the pressure of the working medium supplied from the working medium outlet 5 via the second working medium connection 12 acts. The resulting force also acts against the preload force of the preload element 8, together with the force of the working medium pressure that acts on the first active area 14, and the resulting force is shown by the arrow 24.

In the exemplary embodiment shown, the preload force of the preload element 8 may be variably adjusted by means of an adjusting screw 25.

In the working medium outlet 13 of control valve 6, from which the working medium supplied via the first working medium connection 11 flows, a throttle orifice 16 is furnished so as to limit the quantity of working medium that flows through the control valve 6 and thus past the working chamber 1.

The working medium is pumped at least indirectly from the oil sump 19 into the hydrodynamic machine by means of the working medium pump 18. Due to the fact that the entire quantity of working medium does not always have to be pumped through the hydrodynamic machine and that the working medium pressure in the working medium inlet 4 may be reduced to the minimum required level, the energy consumption or power consumption of the working medium pump 18 is reduced, at least when viewed over the entire operating range in which the working medium pump 18 operates.

In the exemplary embodiment shown, the first active area 14 is formed by a circular area, while the second active area 15 is formed by an annular area. However, this is not mandatory.

Furthermore, the control valve 6 is represented as a piston spool valve, wherein the piston cooperates with bores in a housing that forms the valve seat 10. However, a different embodiment could also be chosen here.

FIG. 2 shows an apparatus 101 for transmitting force, which connects a drive assembly 102 and a working machine 103. The apparatus 101 is formed by a transmission with a hydrodynamic power branch and a purely mechanical power branch furnished parallel thereto. The drive assembly 102 may be designed in particular as a motor, particularly preferably as an electric motor. With the structure shown here, this motor typically provides a constant speed at which it drives an input shaft 104 that is connected to it directly or, if necessary, via a gear stage not shown here. In this case, the working machine 103, which is designed as a working machine 103 with variable speed, is driven via the apparatus 101. The working machine 103 may in particular be a condenser or a compressor, a centrifugal pump or the like. In the exemplary embodiment shown here, it is indirectly connected to an output shaft 106 via a spur gear 105. A connection via a planetary gear, bevel gear or the like would also be possible. The apparatus 101 for transmitting force now comprises a hydrodynamic counter-rotating converter 120, the pump impeller 2 of which is directly connected to the input shaft 104. As is typical for a counter-rotating converter 120, a flow of the working medium occurs from the pump impeller 2 to a turbine impeller 3 via a guide wheel 17, which is adjustable as indicated by the arrow 109.

Parallel thereto, the power is transmitted mechanically directly via the input shaft 104. The two power branches are then brought together again by a planetary gear 111 and together reach the area of the output shaft 106.

The planetary gear 111 has a ring gear 112, a sun gear 113 and a plurality of planets 115 arranged on a planet carrier 114. In the structure shown here, the turbine impeller 3 of the hydrodynamic counter-rotating converter 120 is connected directly to the sun gear 113 of the planetary gear 111 via a hollow shaft 116. Through the hollow shaft 116, the input shaft 114 [sic] is connected to the planet carrier 114 and thus to the individual circumferential planets 115 on the side of the planetary gear 111 facing away from the counter-rotating converter 120. The output shaft 106 is in turn connected to the ring gear 112 of the planetary gear 111.

According to the desired speed or output shaft 106, a corresponding power transmission in the hydrodynamic power branch and thus from the input shaft 114 [sic] to the sun gear 113 is now achieved by adjusting the guide wheel 17 and/or the filling level of the hydrodynamic counter-rotating converter 120 with working medium. This power transmitted via the hydrodynamic power branch is then summed with the main part of the power entered via the planet carrier 114, which is transmitted directly mechanically, and reaches the output shaft 116 via the ring gear 112, as combined power. In the case shown here, the driven machine 113 is then driven via the spur gear 115 with a constant transmission ratio. As a function of the desired instantaneous speed in the area of the working machine 113, the hydrodynamic counter-rotating converter 120 is adjusted accordingly by adjusting the guide wheel 17 and/or varying the amount of working medium in the hydrodynamic counter-rotating converter 120.

As a result, the output speed may be regulated to be very close to the desired speed.

The structure is extremely compact and accordingly easy to implement, since no stationary gear is required, no coupling sleeve has to be used and a comparatively small planetary gear 111 may be used due to the very favorable speeds. Due to the possibilities for mounting the input shaft 114 in particular on the output shaft 116, a structure is created that causes no forces, or no appreciable forces, in the axial direction on the individual elements 112, 113, 115 of the planetary gear 111. This makes it possible to design the individual elements 112, 113, 115 of the planetary gear 111 in a single helical gearing, so that they may be implemented comparatively simply and cost-effectively as a result of both their size and also their design.

The structure overall is very compact, light and may be produced and assembled simply and cost-effectively due to the comparatively small number of individual elements.

The configuration according to FIG. 3 has been changed from the configuration of FIG. 2 with respect to the mounting. For example, the hollow shaft 116 that carries the turbine impeller 3 or is connected to it in a rotationally fixed manner, may be mounted in the transmission housing via bearings, for example ball bearings, in particular angular contact ball bearings. These bearings may absorb axial forces of the turbine. In the exemplary embodiment shown, an additional thrust bearing 121 is furnished for the input shaft 104 and a thrust bearing 122 is provided for the output shaft 106.

The sun gear 113 and the hollow shaft 116 may be connected via a toothed coupling that does not transmit axial force.

Axial forces of the working machine 103 are preferably transmitted to the thrust bearing 122 of the output shaft 106 via a double helical spur gear stage of the spur gear 105.

The planetary gear 111 is also preferably furnished with double helical gearing in order to be able to transfer the axial forces to the bearings.

### LIST OF REFERENCE SIGNS

1 Working chamber
2 Pump impeller
3 Turbine impeller
4 Working medium inlet
5 Working medium outlet
6 Control valve
7 Bypass
8 Preload element
9 Valve body
10 Valve seat
11 First working medium connection
12 Second working medium connection
13 Working medium outlet
14 Active area
15 Active area
16 Throttle orifice
17 Guide wheel
18 Working medium pump
19 Working medium sump
20 Adjusting ring
21 Drive shaft
22 Output shaft
23 Force
24 Force
25 Adjusting screw
101 Apparatus
102 Drive assembly
103 Working machine
104 Input shaft
105 Spur gears
106 Output shaft
109 Arrow of adjustability
111 Planetary gear
112 Ring gear
113 Sun gear
114 Planet carrier
115 Planet
116 Hollow shaft
120 Counter-rotating converter
121 Thrust bearing
122 Thrust bearing

1-13. (canceled)

14. A hydrodynamic machine, comprising:
at least one bladed pump impeller;
at least one bladed turbine impeller;
a working chamber to be filled with a working medium and in which said at least one bladed pump impeller and said at least one bladed turbine impeller are disposed in order to hydrodynamically transmit torque and/or drive power from said at least one bladed pump impeller to said at least one bladed turbine impeller;
a working medium inlet for supplying the working medium into said working chamber;
a working medium outlet for discharging the working medium out of said working chamber;
a bypass for the working medium that branches off from said working medium inlet;
a control valve disposed in said working medium inlet or in said bypass, said control valve used to change a working medium quantity flowing into said working chamber by adjusting a flow cross-section for the working medium flowing through said control valve; and
said control valve is connected to said working medium inlet and/or said working medium outlet and actuated such that the flow cross-section of said control valve is variably adjusted in dependence on a working medium pressure in said working medium inlet and a working medium pressure in said working medium outlet.

15. The hydrodynamic machine according to claim 14, wherein said control valve has a valve body that is preloaded by means of a preload element and cooperates with a valve seat to limit and adjust the flow cross-section, wherein a preload force of said preload element may be varied.

16. The hydrodynamic machine according to claim 14, wherein said control valve is disposed in said bypass and has a valve body that is preloaded by means of a preload element and cooperates with a valve seat to limit and adjust the flow cross-section, wherein said preload element acts on said valve body in a closing direction of said control valve, and said valve body is subjected to a force contrary to a preload force of said preload element in dependence on the working medium pressure in said working medium inlet and said working medium outlet.

17. The hydrodynamic machine according to claim 16, wherein:
said valve body has an active area being a common active area or a plurality of active areas; and
said control valve has a first working medium connection, a second working medium connection and a working medium outlet, wherein said first working medium connection is connected to said working medium inlet in a working medium-conducting manner and said second working medium connection is connected to said working medium outlet in a working medium-conducting manner, said first working medium connection is connected to said working medium outlet in a working medium-conducting manner via the flow cross-section, and said first working medium connection and said second working medium connection are respectively connected in a working medium-conducting manner to said active area on said valve body in order to pressurize said valve body against the preload force of said preload element.

18. The hydrodynamic machine according to claim 16, wherein said control valve is a piston spool valve.

19. The hydrodynamic machine according to claim 16, wherein said preload element is a compression spring.

20. The hydrodynamic machine according to claim 19, wherein said compression spring acts on a first side of said valve body configured as a piston and said common active area or said active areas is/are furnished on a side of said valve body opposite thereto.

21. The hydrodynamic machine according claim 17, wherein said control valve has a throttle orifice disposed in said working medium outlet.

22. The hydrodynamic machine according to claim 14,
wherein said hydrodynamic machine is a hydrodynamic converter; and
further comprising at least one bladed guide wheel disposed in said working chamber, in addition to said at least one bladed pump impeller and said at least one bladed turbine impeller.

23. The hydrodynamic machine according to claim 22, wherein said hydrodynamic converter is configured as an actuating converter, having an actuating member with which a torque ratio of the torque applied to said at least one bladed pump impeller and said at least one bladed turbine impeller may be varied, said actuating member being formed by blades of said at least one bladed pump impeller and/or of said bladed guide wheel which are adjustable relative to a flow of the working medium in said working chamber.

24. The hydrodynamic machine according to claim 15, wherein the preload force of said preload element may be varied manually.

25. A drive train, comprising:
a hydrodynamic machine according to claim 14;
a working medium supply having a working medium pump, said working medium pump connected to said working medium inlet with a pressure side in a working medium-conducting manner in order to supply said hydrodynamic machine with a pressurized working medium; and
a working medium sump from which said working medium pump is connected at least indirectly to a suction side, said bypass with said control valve opening directly or indirectly into said working medium sump.

26. The drive train according to claim 25,
wherein said hydrodynamic machine is furnished in a hydrodynamic power branch to which a purely mechanical power branch is connected in parallel in a direction of a drive power flow;
further comprising an output shaft; and
further comprising a superposition gear, in a form of a planetary gear having a ring gear, a sun gear and a planet carrier with a plurality of planets, that superimposes a drive power transmitted with the hydrodynamic power branch and the purely mechanical power branch and feeds power to said output shaft.

27. The drive train according to claim 26, further comprising:
a drive assembly rotating at a constant speed; and
a working machine rotating at a variable speed and connected at least indirectly to said output shaft.
